(19) United States
(12) Patent Application Publication
(10) Pub. No.: US 2026/0162368 A1
(43) Pub. Date: Jun. 11, 2026

(54) Systems and Methods for Graphics Enhanced Content Placement

(71) Applicant: Illuscio, Inc., Culver City, CA (US)

(72) Inventor: Joseph Bogacz, Perth (CA)

(73) Assignee: Illuscio, Inc., Culver City, CA (US)

(21) Appl. No.: 18/973,994

(22) Filed: Dec. 9, 2024

(51) Int. Cl. G06T 17/20; G06T 7/70; G06T 9/00

(52) U.S. Cl. CPC G06T 17/20; G06T 7/70; G06T 9/001

(57) ABSTRACT

A scene generation system provide graphics enhanced content placement in the quality or fidelity of promoted visual assets in a scene are adjusted relative to other or non-promoted visual assets in the same scene. The different quality or fidelity at which the promoted visual assets are presented draw viewer focus to the promoted visual assets without prominently positioning the promoted visual assets in the scene or otherwise altering the creative intent for the scene. The system receives a request to promote a particular visual asset in a scene, determines a first level-of-detail (LoD) at which to render the visual assets of the scene, selects a second LoD that is greater than the first LoD for the particular visual asset, and presents the scene by rendering the non-promoted visual assets at the first LoD and the particular visual asset at the second LoD.

### BACKGROUND

Product placement is a form of embedded marketing that involves advertisers, product creators, and/or other content creators paying to have their products or content appear in the visual works of others. Product placement is used to build brand recognition, advertise through alternative means (e.g., content that users are interested in viewing), and/or associate a product with other products, persons (e.g., actors, influencers, celebrities, etc.), and/or other content.

The product placement effectiveness may vary based on where the promoted product or content appears in the visual work, the duration that the promoted product or content appears in the visual work, and the visual work viewership. In some cases, the promoted product may be displayed with other products or may be presented in a scene without any differentiation. In such cases, there is nothing to draw the viewer focus to the promoted product. Accordingly, there is a need for alternative or new means to draw attention to a promoted product or content in a visual work, and thereby increase or improve the product placement effectiveness.

### BRIEF DESCRIPTION OF THE DRAWINGS

FIG. 1 illustrates an example of the graphics enhanced content placement in accordance with some embodiments presented herein.

FIG. 2 presents a process for generating a scene or content with graphics enhanced content placement in accordance with some embodiments presented herein.

FIG. 3 illustrates an example of rendering a three-dimensional (3D) asset at different levels-of-detail (LoDs) or fidelities in accordance with some embodiments presented herein.

FIG. 4 illustrates an example for different enhancements of promoted visual assets in a visually differentiated scene in accordance with some embodiments presented herein.

FIG. 5 presents a process for dynamically adapting the LoD or fidelity of promoted visual assets in a scene to match other prioritized visual assets without exceeding available resources in accordance with some embodiments presented herein.

FIG. 6 illustrates example components of one or more devices, according to one or more embodiments described herein.

### DETAILED DESCRIPTION OF PREFERRED EMBODIMENTS

The following detailed description refers to the accompanying drawings. The same reference numbers in different drawings may identify the same or similar elements.

Provided are systems and associated methods for graphics enhanced content placement. The graphics enhanced content placement includes dynamically adjusting the quality or fidelity of promoted visual assets in a scene of a visual work relative to other or non-promoted visual assets in the same scene. The different quality or fidelity at which the promoted visual assets are presented draw viewer focus to the promoted visual assets without prominently positioning the promoted visual assets in the scene or otherwise altering the creative intent for the scene.

In some embodiments, an advertiser or promoter may pay a fee for inclusion and/or visual differentiation of their visual asset in the scene. The scene may be part of an image, movie, game, video, animation, virtual environment, interactive environment, three-dimensional (3D) environment, or other visual work. A scene generator may differentiate the promoted visual asset (e.g., the visual asset of the advertiser or promoter) from other visual assets included in the scene by rendering or generating a visualization of the promoted visual asset at a different level-of-detail (LoD) or fidelity than the other visual assets in the scene or the other visual assets that are positioned at the same depth in the scene as the promoted visual asset. Consequently, the promoted visual asset is presented with greater detail, sharpness, and/or clarity relative to the other visual assets and visually stands out in the scene without changing the creative intent of the scene by repositioning the promoted visual asset to be more prominently displayed in the scene.

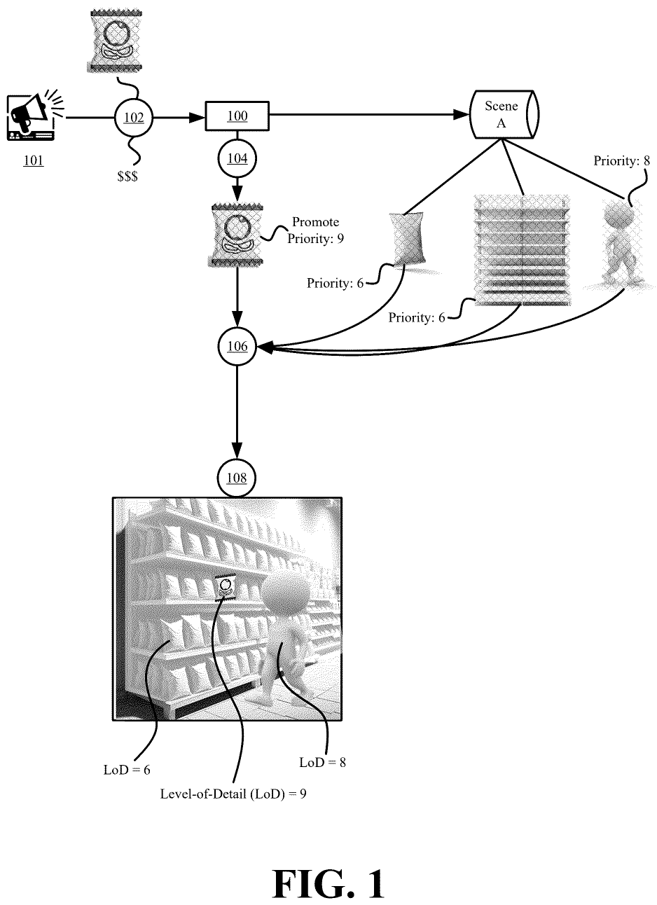

FIG. 1 illustrates an example of the graphics enhanced content placement in accordance with some embodiments presented herein. Scene generator 100 receives (at 102) a request from content originator 101 to include and/or promote a two-dimensional (2D) or 3D asset provided by content originator 101 in a scene that is formed from various 2D or 3D digital assets. The request may include or may be accompanied by a copy of content originator's 101 2D or 3D asset. Content originator's 101 2D or 3D asset may include an image, animation, video, or 3D model. The 3D model may be a 3D mesh model that is defined using meshes or polygons, a point cloud that is defined using a distributed set of points, a 3D splat representation that is defined using Gaussian splats, or another 3D format that is defined using another 3D primitive. The request may specify the scene or visual work to include the promoted 2D or 3D asset. The request may also include a monetary payment, an agreement to cross-promote in each other's content, or other incentive for the promotion of content originator's 101 2D or 3D asset in the scene.

Scene generator 100 tags (at 104) content originator's asset in response to the received (at 102) request. Tagging (at 104) the asset includes associating an identifier or label to the asset to indicate that it is promotional content and/or to visually differentiate the asset from other assets that are included in the scene. In some embodiments, tagging (at 104) the asset includes providing a higher priority value to content originator's asset than other non-promotional assets included in the scene.

Scene generator 100 retrieves (at 106) different assets that collectively form the scene including content originator's 101 asset. In some embodiments, a scene definition specifies the list of assets that form the scene and a position for each asset in the scene. The position of each asset may be defined in a 3D space. The scene definition may specify additional information such as a size, rotation, or other transformation to apply to an asset prior to including that asset in the scene. In some embodiments, the scene is defined by a graphics artist, director, or user. Accordingly, content originator 101 may have no or little influence over the placement or positioning of their asset in the scene, and the placement or positioning of content originator's 101 asset may be left to the director's creative intent. In some such embodiments, the director positions each asset in a 2D or 3D space or programmatically defines the positions and/or animations for each asset. For instance, the assets may include 3D models of different objects that are included in a game. Some of the objects may be static background elements for the game. Other objects may be animated or interactive elements of the game that a player controls or are controlled by algorithms or in response to interactions with other game elements.

Scene generator 100 generates (at 108) a visual representation of the scene by rendering the different assets at different LoDs or fidelities according to the tags or priorities associated with the assets. Specifically, scene generator 100 may render tagged (at 104) promotional assets at a higher LoD or fidelity than other assets of the scene that are not tagged or that have a lower priority. For 2D assets, rendering at the higher LoD may include rendering the tagged (at 104) promotional assets at a higher or greater resolution than the resolution at which other assets are rendered. For 3D assets, rendering at the higher LoD may include rendering the tagged (at 104) promotional assets with a greater number of smaller-sized 3D primitives than other 3D assets that may be rendered with a downsampled or lower number of larger-sized 3D primitives.

Scene generator 100 generates (at 108) the visual representation so that the tagged (at 104) promotional assets appear clearer, sharper, and/or more defined relative to the other rendered assets of the scene regardless of the positioning of the assets in the scene. The viewer focus may be drawn to the clearer, sharper, or more defined visual elements in the scene regardless of their positioning in the scene such that content originator 101 receives the added exposure and/or viewing of their assets without changing the creative intent of the scene by repositioning the tagged (at 104) promotional assets to be more prominently displayed in the center or foreground of the scene.

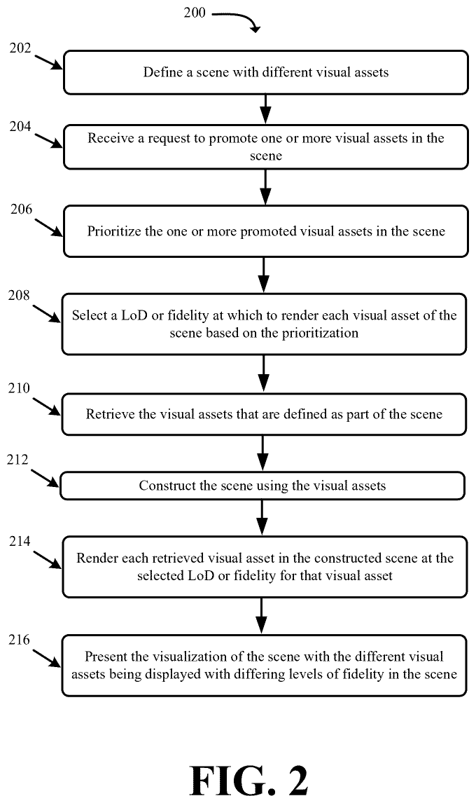

FIG. 2 presents a process 200 for generating a scene or content with graphics enhanced content placement in accordance with some embodiments presented herein. Process 200 is implemented by scene generator 100. Scene generator 100 includes one or more devices or machines with processor, memory, storage, network, and/or other hardware resources that generate a scene or content with different LoDs or fidelities for the visual assets included in that scene or content in order to enhance the graphical presentation of promoted assets without changing the creative intent of the scene or content or the positioning of the assets in the scene or content.

Process 200 includes defining (at 202) a scene with different visual assets. Defining (at 202) the scene may include specifying which visual assets are included in the scene and/or the size, position, orientation, and/or any animation for the visual assets in the scene. In some embodiments, the scene may be a static scene such as a 2D image or a static 3D environment. In some other embodiments, the scene may be one of many that is generated over the playback of a video, animation, game, interactive environment, or other changing visualization. In some such embodiments, the visual assets may be defined with animation frameworks, physics models, and/or motion that is applied programmatically, in response to user controls, or in response to interactions with other visual assets.

In some embodiments, defining (at 202) the scene includes generating a scene definition with the filenames, Uniform Resource Locators (URL), or other identifiers for each of the different visual assets included in the scene, and with arrangement information for each visual asset. The arrangement information may include a position, size, rotation, orientation, and/or other transformations for each visual asset in a 2D or 3D space. In some embodiments, the scene definition corresponds to one function, code, or file of a larger application (e.g., game, animation, interactive environment, etc.). In some such embodiments, the scene definition may be the block of code that lists which assets are loaded into a scene at what time.

Process 200 includes receiving (at 204) a request to promote one or more visual assets in the scene. The request may be accompanied with a form of payment or some incentive for the promotion of the one or more visual assets. For instance, a first company may request that visual assets of their products be promoted in a print or media advertisement for products of a second company, and, in return, the first company may promote visual assets of the second company products in a print or media advertisement for products of the first company. The request may include the filename, URL, or identifier for each visual asset that is requested for promotion. Alternatively, the request may include a copy of the one or more visual assets, wherein the copy may include a file that encodes the 2D or 3D data for the one or more visual assets.

Process 200 includes prioritizing (at 206) the one or more promoted visual assets in the scene. The prioritization (at 206) may include adding a priority value to the one or more promoted visual assets that is greater than a priority value assigned to other non-promoted visual assets of the scene. In some embodiments, the priority value corresponds to a LoD or fidelity at which the one or more promoted visual assets are to be rendered. The LoD or fidelity for the one or more promoted visual assets is greater than the LoD or fidelity for the other non-promoted visual assets of the scene. For instance, scene generator 100 may generate a scene with LoDs or fidelities ranging from 1-10 with each value corresponding to a different resolution or quality level. A value of 10 may specify rendering a visual asset at its original resolution, and a value of 1 may specify rendering the same visual asset at half of its original resolution or compressed with a specified amount of loss (e.g., 50% loss). Alternatively, the prioritization (at 206) may include tagging the one or more promoted visual assets with a label or identifier that differentiates the one or more promoted visual assets from the other non-promoted visual assets of the scene.

Process 200 includes selecting (at 208) a LoD or fidelity at which to render each visual asset of the scene based on the prioritization (at 206). In the most basic embodiments, scene generator 100 selects (at 208) a LoD or fidelity for the one or more promoted visual assets that is greater than the LoD or fidelity for the other non-promoted visual assets. For instance, scene generator 100 selects (at 208) a LoD value of 9 for the one or more promoted visual assets and a LoD value of 7 for the non-promoted visual assets, wherein the LoD value of 9 corresponds to an original resolution or maximum resolution at which the visual assets may be rendered and the LoD value of 7 corresponds to a reduced or downsampled resolution (e.g., 20% reduction in the original resolution or the maximum resolution). In some other embodiments, scene generator 100 selects (at 208) the LoD or fidelity based on the positioning of the visual assets in the scene. For instance, scene generator 100 may select (at 208) an initial LoD or fidelity value of 5 for visual assets in the background or periphery of the scene and an initial LoD or fidelity value of 7 for visual assets in the foreground or center of the scene. Scene generator 100 may increase the LoD or fidelity value for a promoted visual asset in the background or periphery from 5 to 7, and may increase the LoD or fidelity value for a promoted visual asset in the foreground or center from 7 to 9 so that the foreground and background visual assets are visually differentiated from one another and so that the promoted visual assets are further differentiated in whichever plane or position they are located. In still some other embodiments, scene generator 100 selects (at 208) the LoD and fidelity for the visual assets in the scene dynamically based on available bandwidth or visual asset importance. For instance, the promoted visual assets may be prioritized to have the same LoD or fidelity as visual assets corresponding to actors or playable characters, other dynamic or animated visual assets may be assigned a lower medium LoD or fidelity, and static visual assets may be assigned a lowest LoD or fidelity.

Process 200 includes retrieving (at 210) the visual assets that are defined (at 202) as part of the scene. Each visual asset may be stored or encoded to a separate file or data structure. Each visual asset may be defined at a common resolution or fidelity or at different resolutions or fidelities. Scene generator 100 may retrieve (at 210) the visual assets from a database or a non-volatile storage medium. In some embodiments, the visual assets are automatically retrieved (at 210) as part of a rendering engine, game engine, enhanced reality engine, or other graphics engine loading the visual assets in order to construct the scene.

Process 200 includes constructing (at 212) the scene using the visual assets. The scene construction (at 212) includes positioning and/or transforming the visual assets to have sizes, orientations, rotations, and/or properties specified in the scene definition. In other words, scene generator 100 builds a 2D or 3D environment with the visual assets from which to generate the full visualization of the scene.

Process 200 includes rendering (at 214) each retrieved (at 210) visual asset in the constructed (at 212) scene at the selected (at 208) LoD or fidelity for that visual asset. Rendering (at 214) the visual assets includes generating a higher quality, clearer, sharper, and/or more detailed visualization for the one or more promoted visual assets than for other non-promoted or unprioritized visual assets of the scene.

Process 200 includes presenting (at 216) the visualization of the scene with the different visual assets being displayed with differing levels of fidelity in the scene. In doing so, the viewer focus may be drawn to the sharper or more detailed visual assets regardless of where they may be located in the scene because of the visual differentiation that is created from rendering (at 214) the visual assets at the differing levels of fidelity.

In some embodiments, scene generator 100 may select the LoD or fidelity of the promoted visual assets to be slightly greater than the LoD or fidelity of the non-promoted visual assets so as to avoid creating discontinuity or stark visual differences in the scene. In some other embodiments, scene generator 100 may select the LoD or fidelity of the promoted visual assets to be significantly greater than the LoD or fidelity of the non-promoted visual assets so as to purposely create discontinuity in the overall scene and/or to create stark visual differences that noticeably cause the promoted visual assets to stand out from the rest of the scene or apart from the non-promoted visual assets.

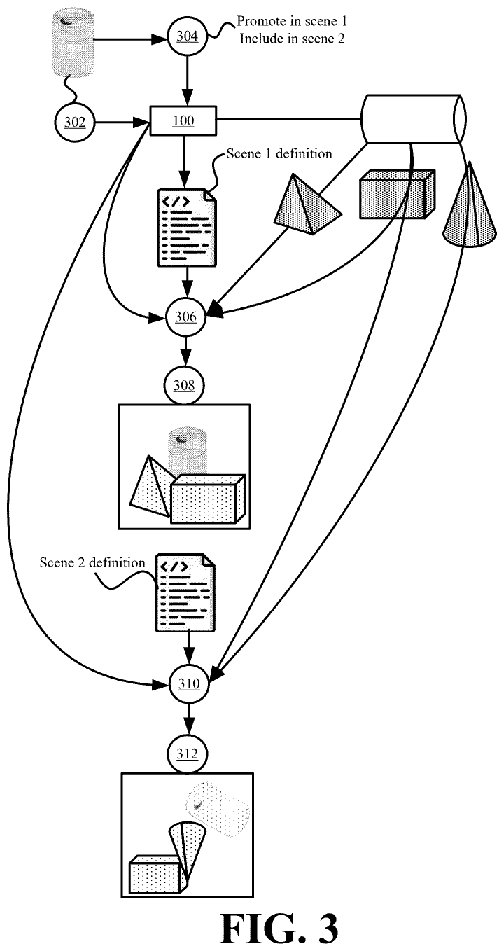

FIG. 3 illustrates an example of rendering a 3D asset at different LoDs or fidelities in accordance with some embodiments presented herein. Scene generator 100 receives (at 302) an original encoding of the 3D asset. The original encoding of the 3D asset may define the form, shape, and visual characteristics of a 3D object with a first set of 3D primitives (e.g., meshes, points, Gaussian splats, etc.). In some embodiments, the original encoding of the 3D asset may represent the 3D object at the highest available LoD or fidelity. In this example, the original encoding of the 3D asset is a point cloud representation of a soda can. The point cloud representation uses a densely distributed first set of points to create the form, shape, and visual characteristics of the soda can at a high fidelity or resolution. The original encoding of a 2D asset may define the form, shape, and visual characteristics of a represented object with a first set of pixels.

Scene generator 100 receives (at 304) a request to promote and/or graphically enhance the 3D asset in a first scene and to include the 3D asset in a second scene without promotion. For instance, the 3D asset creator or promotor may expect greater exposure from the first scene or the first scene may target a desired demographic for the product represented by the 3D asset and the second scene may not target the desired demographic.

Scene generator 100 includes (at 306) and promotes the 3D asset in the first scene. The first scene may be defined with a first set of 3D assets that are to be rendered at a first resolution or LoD that is less than the LoD or fidelity at which the 3D asset is encoded.

Scene generator 100 renders (at 308) the first set of 3D assets at the first resolution or LoD and the 3D asset at a second resolution or LoD that is greater than the first resolution or LoD. Rendering (at 308) the 3D asset at the second resolution or LoD may include rendering the first set of 3D primitives from the original encoding of the 3D asset or a downsampled subset of the first set of 3D primitives that still creates a visualization of the 3D asset at a higher resolution or LoD than the other 3D assets of the first scene. For instance, the downsampled subset of the first set of 3D primitive may include a greater number and/or denser distribution of 3D primitives than the 3D primitives used to represent the other assets of the first scene.

Scene generator 100 includes (at 310) the 3D asset without promotion in the second scene. The second scene may be defined with a second set of 3D assets that are to be rendered at the first resolution or LoD. Since the 3D asset is not promoted in the second scene, scene generator 100 renders (at 312) the second set of 3D assets and the 3D asset at the first resolution or LoD and the 3D asset by reducing the number of 3D primitives that represent the 3D asset and rendering (at 312) the reduced set of 3D primitives in order to create the visualization of the 3D asset in the second scene. The reduced set of 3D primitives have fewer larger primitives to represent the shape, form, and visual characteristics of the 3D object than the original first set of 3D primitives. The resulting visualization produced by the reduced set of 3D primitives will lose detail, sharpness, clarity, and/or other definition relative to the visualization produced by the original first set of 3D primitives. Moreover, the 3D asset is not visually differentiated in terms of quality or detail relative to other assets of the second scene.

Scenes generated by scene generator 100 may already include visual differentiation for visual assets rendered at different depths or positions within those scenes. For instance, to save compute resources and reduce the amount of data in a 3D scene, scene generator 100 may render visual assets in the background or in the periphery of the 3D scene at a lower LoD or fidelity than visual assets in the foreground or in the center of the 3D scene. The visual assets in the background or in the periphery will draw less of the viewer focus or attention than the visual assets in the foreground or in the center, and therefore may be rendered at the lower LoD or fidelity. Similarly, the visual assets in the background are typically presented at a smaller size and are expected to be less clear than the visual assets in the foreground when accurately simulating human vision in a 3D environment. Accordingly, the quality loss associated with rendering the visual assets in the background at the lower LoD or fidelity creates a more visually accurate 3D scene that matches viewer expectations of how the 3D scene is to look.

Scene generator 100 may adapt the graphics enhanced content placement for scenes that are rendered with visual differentiation. Specifically, scene generator 100 boosts the LoD or fidelity for the promoted visual assets relative to other non-promoted visual assets in the same depth or region of the scene as the promoted visual assets.

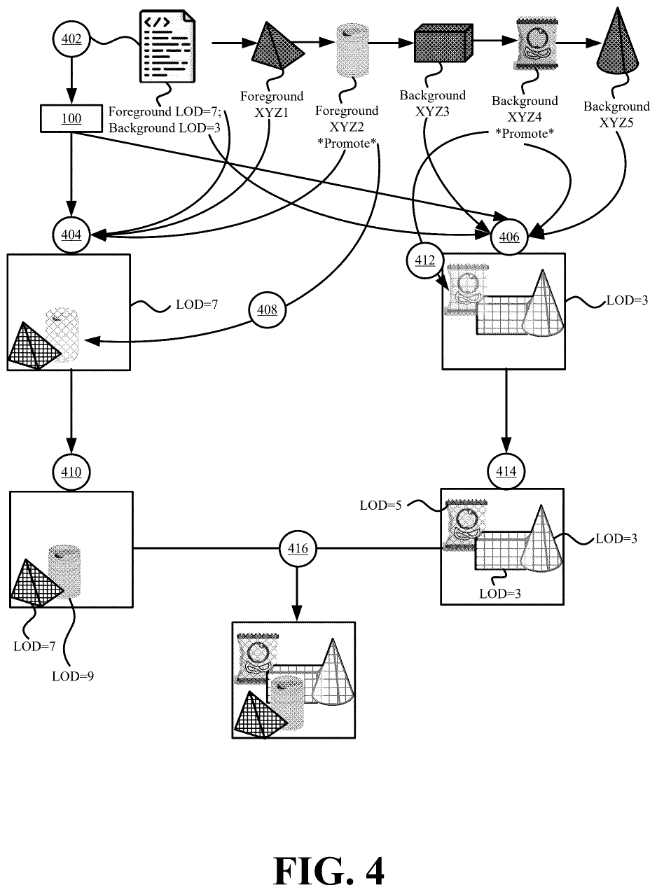

FIG. 4 illustrates an example for different enhancements of promoted visual assets in a visually differentiated scene in accordance with some embodiments presented herein. Scene generator 100 receives (at 402) a scene definition that includes multiple visual assets in the foreground and in the background of the scene with a first visual asset in the foreground being selected for promotion and a second visual asset in the background being selected for promotion and with the scene definition specifying different LoDs at which to render the foreground and background visual assets.

Accordingly, scene generator 100 selects a first LoD or fidelity at which to render (at 404) the foreground visual elements including the first visual asset and a lower or reduced second LoD or fidelity at which to render (at 406) the background visual elements including the second visual asset. In some embodiments, scene generator 100 may select additional LoD or fidelities for visual assets at different depths between the nearest foreground plane or depth and the farthest background plane or depth. In any case, scene generator 100 selects the different LoDs or fidelities to create a realistic visualization of the scene and/or to reduce the rendering resources and the amount of data associated with generating the scene visualization.

Scene generator 100 determines (at 408) that the first visual asset is tagged for promotion and is located in the scene foreground. Scene generator 100 adjusts (at 410) the first LoD or fidelity that is assigned to the first visual asset in response to determining (at 408) that the first visual asset is tagged for promotion and is located in the scene foreground. Specifically, scene generator 100 increases the first LoD or fidelity to a higher third LoD or fidelity that causes the first visual asset to be rendered with greater resolution, detail, clarity, and/or sharpness relative to the other foreground visual elements being rendered at the first LoD or fidelity.

Scene generator 100 determines (at 412) that the second visual asset is tagged for promotion and is located in the scene background. Scene generator 100 adjusts (at 414) the second LoD or fidelity that is assigned to the second visual asset in response to determining (at 412) that the second visual asset is tagged for promotion and is located in the scene background. Scene generator 100 increases the second LoD or fidelity to a higher fourth LoD or fidelity that causes the second visual asset to be rendered with greater detail relative to the other foreground visual elements being rendered at the second LoD or fidelity. The fourth LoD or fidelity may be less than the first LoD or fidelity at which the foreground visual elements are rendered and less than the third LoD or fidelity at which the promoted first visual element is rendered.

Scene generator 100 renders (at 416) the visual elements of the scene at the LoD or fidelity that is specified for each visual element. Accordingly, all the background visual elements except for the second visual element are rendered (at 416) at the second LoD or fidelity and all the foreground visual elements except for the first visual element are rendered (at 416) at the first LoD or fidelity. The second visual element is rendered with more detail, clarity, and/or sharpness relative to the background visual elements so that it is visually differentiated in the scene background. Similarly, the first visual element is rendered with more detail, clarity, and/or sharpness relative to the foreground visual elements so that it is visually differentiated in the scene foreground.

In some embodiments, scene generator 100 dynamically adapts the LoD or fidelity of the promoted visual assets to differentiate from unprioritized visual assets of a scene without taking away viewer focus from other important or prioritized visual assets of the scene. In some such embodiments, scene generator 100 preserves the creative intent of the scene while still differentiating the promoted visual assets from the unprioritized visual assets. For instance, the scene may present an actor at a high LoD or fidelity to draw the viewer focus. Rather than increase the LoD or fidelity of a promoted visual asset to compete or draw the viewer focus away from the actor, scene generator 100 may match the LoD or fidelity of the promoted visual asset to the LoD or fidelity or actor or present the promoted visual asset at a slightly reduced LoD or fidelity that is still greater than the LoD or fidelity at which other visual assets are presented or rendered in the scene.

In some embodiments, scene generator 100 dynamically adapts the LoD or fidelity of the prioritized and/or promoted visual assets based on available resources. The available resources may include streaming or networking resources for transmitting the scene data to a remote client device for presentation. The available resources may also include the rendering resources of the remote client device that are available to render the scene data at a desired frame rate.

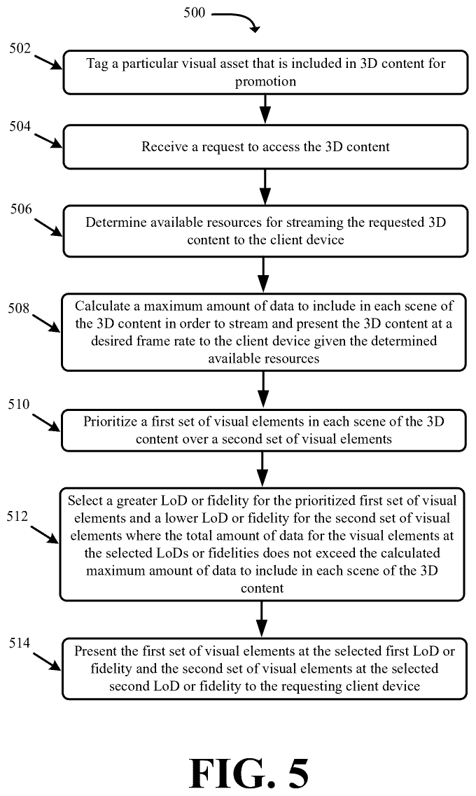

FIG. 5 presents a process 500 for dynamically adapting the LoD or fidelity of promoted visual assets in a scene to match other prioritized visual assets without exceeding available resources in accordance with some embodiments presented herein. Process 500 is implemented by scene generator 100 when scene generator 100 is integrated as part of a streaming platform for distributing 2D or 3D content to remote client devices or is integrated as part of rendering engine of a remote client device for dynamically scaling LoD or fidelity of a scene or content.

Process 500 includes tagging (at 502) a particular visual asset that is included in a 3D content for promotion. The tagging (at 502) may be performed in response to a request issued by the creator of the particular visual asset or in response to receiving a benefit or incentive to promote the particular visual asset. The 3D content may include a movie, video, game, or spatial computing experience that is remotely accessed from scene generator 100 or a streaming platform where scene generator 100 executes. The particular visual asset may include a static or dynamic element that is included and presented as part of the 3D content in one or more scenes.

Process 500 includes receiving (at 504) a request to access the 3D content. The request is issued by a client device that attempts to remotely access the 3D content over a data network. The request may include the name, URL, or other identifier for accessing the 3D content and may be issued as a HyperText Transfer Protocol (HTTP) GET message or other request message format.

Process 500 includes determining (at 506) available resources for streaming the requested 3D content to the client device. Determining (at 506) the available resources may include measuring bandwidth or performance of the data network connecting scene generator 100 to the requesting client device. Determining (at 506) the available resources may include identifying the processing and/or rendering resources of the client device. In some embodiments, the client device may identify the processor, Graphics Processing Unit (GPU), available memory, and/or other hardware resources that are configured and available on the client device for rendering the 3D content, and may determine (at 506) the amount of data that those resources may render at a given frame rate.

Process 500 includes calculating (at 508) a maximum amount of data to include in each scene of the 3D content in order to stream and present the 3D content at a desired frame rate to the client device given the determined (at 506) available resources. When there is more available bandwidth and greater rendering resources on the client device, each scene of the 3D content may contain more data (e.g., select higher LoDs or fidelities at which to render the visual assets) in order to generate the visualization of the scene with greater detail.

Process 500 includes prioritizing (at 510) a first set of visual elements in each scene of the 3D content over a second set of visual elements. The prioritization includes identifying the visual elements that are likely or designated to receive the viewer focus. For instance, visual elements that are likely or designated to receive the viewer focus include visual elements associated with playable or controlled characters, actors, faces, central and/or foreground elements, visual elements with lots of color variation, dynamic or animated elements, and/or other visual elements that are tagged with high priorities including the particular visual asset that is tagged (at 502) for promotion. The prioritization (at 510) may also be based on or may account for the positioning of the visual elements in the scene. Background or peripheral visual elements may not be prioritized (at 510) or may receive a low priority value, whereas foreground or central visual elements may be prioritized (at 510) or may receive high priority value.

Process 500 includes selecting (at 512) a greater LoD or fidelity for the prioritized (at 510) first set of visual elements and a lower LoD or fidelity for the second set of visual elements where the total amount of data for the visual elements at the selected (at 512) LoDs or fidelities does not exceed the calculated (at 508) maximum amount of data to include in each scene of the 3D content. Scene generator 100 selects (at 512) the different LoDs or fidelities to ensure that the first set of visual elements are rendered and/or presented with greater detail or resolution than the second set of visual elements but without violating the maximum amount of data that may be included in the 3D content scene.

Process 500 includes presenting (at 514) the first set of visual elements at the selected (at 512) first LoD or fidelity and the second set of visual elements at the selected (at 512) second LoD or fidelity to the requesting client device. Presenting (at 514) the visual elements may include streaming the pixels or 3D primitives for each visual element at the selected (at 512) LoD or fidelity. Presenting (at 514) the visual elements may include rendering the visual elements for each scene of the 3D content at the LoD or fidelity selected (at 512) for each visual element and streaming the visualization that is generated for each scene from the rendered visual elements to the requesting client device.

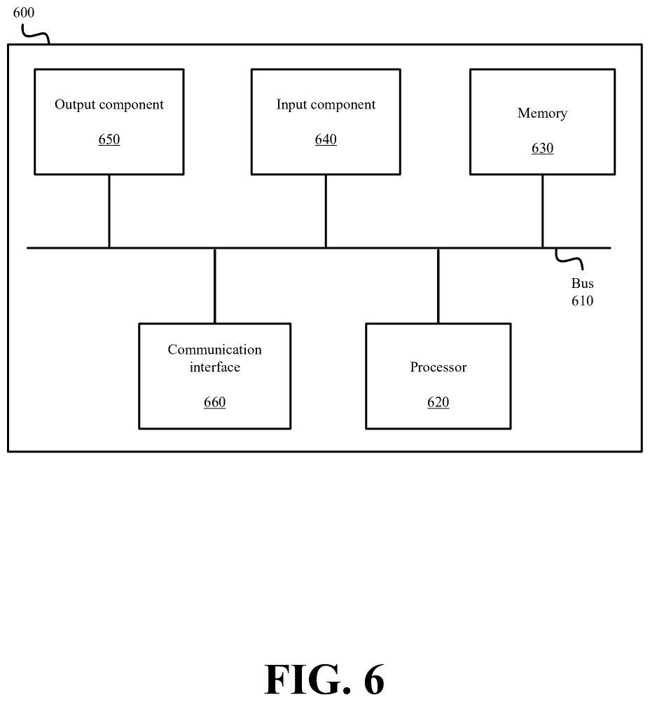

FIG. 6 is a diagram of example components of device 600. Device 600 may be used to implement one or more of the tools, devices, or systems described above (e.g., scene generator 100, requesting client devices, etc.). Device 600 may include bus 610, processor 620, memory 630, input component 640, output component 650, and communication interface 660. In another implementation, device 600 may include additional, fewer, different, or differently arranged components.

Bus 610 may include one or more communication paths that permit communication among the components of device 600. Processor 620 may include a processor, microprocessor, or processing logic that may interpret and execute instructions. Memory 630 may include any type of dynamic storage device that may store information and instructions for execution by processor 620, and/or any type of non-volatile storage device that may store information for use by processor 620.

Input component 640 may include a mechanism that permits an operator to input information to device 600, such as a keyboard, a keypad, a button, a switch, etc. Output component 650 may include a mechanism that outputs information to the operator, such as a display, a speaker, one or more LEDs, etc.

Communication interface 660 may include any transceiver-like mechanism that enables device 600 to communicate with other devices and/or systems. For example, communication interface 660 may include an Ethernet interface, an optical interface, a coaxial interface, or the like. Communication interface 660 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 600 may include more than one communication interface 660. For instance, device 600 may include an optical interface and an Ethernet interface.

Device 600 may perform certain operations relating to one or more processes described above. Device 600 may perform these operations in response to processor 620 executing software instructions stored in a computer-readable medium, such as memory 630. A computer-readable medium may be defined as a non-transitory memory device. A memory device may include space within a single physical memory device or spread across multiple physical memory devices. The software instructions may be read into memory 630 from another computer-readable medium or from another device. The software instructions stored in memory 630 may cause processor 620 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations.

The actual software code or specialized control hardware used to implement an embodiment is not limiting of the embodiment. Thus, the operation and behavior of the embodiment has been described without reference to the specific software code, it being understood that software and control hardware may be designed based on the description herein.

For example, while series of messages, blocks, and/or signals have been described with regard to some of the above figures, the order of the messages, blocks, and/or signals may be modified in other implementations. Further, non-dependent blocks and/or signals may be performed in parallel. Additionally, while the figures have been described in the context of particular devices performing particular acts, in practice, one or more other devices may perform some or all of these acts in lieu of, or in addition to, the above-mentioned devices.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown, in practice, additional, fewer, or different, connections or devices may be used. Furthermore, while various devices and networks are shown separately, in practice, the functionality of multiple devices may be performed by a single device, or the functionality of one device may be performed by multiple devices. Further, while some devices are shown as communicating with a network, some such devices may be incorporated, in whole or in part, as a part of the network.

To the extent the aforementioned embodiments collect, store or employ personal information provided by individuals, it should be understood that such information shall be used in accordance with all applicable laws concerning protection of personal information. Additionally, the collection, storage and use of such information may be subject to consent of the individual to such activity, for example, through well-known “opt-in” or “opt-out” processes as may be appropriate for the situation and type of information. Storage and use of personal information may be in an appropriately secure manner reflective of the type of information, for example, through various encryption and anonymization techniques for particularly sensitive information.

Some implementations described herein may be described in conjunction with thresholds. The term “greater than” (or similar terms), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “exceeding” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

1. A method comprising:
receiving a request to promote a particular visual asset from a plurality of visual assets that form a scene;
determining at least a first level-of-detail (LoD) at which to render the plurality of visual assets;
selecting a second LoD that is greater than the first LoD for the particular visual asset in response to receiving the request to promote the particular visual asset; and
presenting the scene by rendering each visual asset of the plurality of visual assets except for the particular visual asset at the at least first LoD and the particular visual asset at the second LoD.

2. The method of claim 1,
wherein rendering each visual asset of the plurality of visual assets except for the particular visual asset at the at least first LoD comprises:
generating a visualization for each visual asset of the plurality of visual assets except for the particular visual asset in the scene with a first resolution or fidelity; and
wherein rendering the particular visual asset at the second LoD comprises:
generating a visualization for the particular visual asset in the scene with a second resolution or fidelity that is greater than the first resolution or fidelity.

3. The method of claim 1, wherein said rendering comprises:
generating a visualization for each visual asset of the plurality of visual assets except for the particular visual asset in the scene with a reduced clarity, detail, or sharpness relative to a visualization that is generated for the particular visual asset in the scene.

4. The method of claim 1,
wherein determining the at least first LoD comprises:
selecting the first LoD for a first set of visual assets that are positioned in a background or a periphery of the scene, and a third LoD for a second set of visual assets that are positioned in a foreground or a center of the scene; and
wherein selecting the second LoD comprises:
increasing the first LoD to the second LoD for the particular visual asset in response to the particular visual asset being located in the background or the periphery of the scene and the second LoD being less than the third LoD.

5. The method of claim 1,
wherein determining the at least first LoD comprises:
selecting the first LoD for a first set of visual assets that are positioned in a foreground or a center of the scene, and a third LoD for a second set of visual assets that are positioned in a background or a periphery of the scene; and
wherein selecting the second LoD comprises:
increasing the first LoD to the second LoD for the particular visual asset in response to the particular visual asset being located in the foreground or the center of the scene and the second LoD being greater than the third LoD.

6. The method of claim 1 further comprising:
receiving a monetary compensation with the request to promote the particular visual asset.

7. The method of claim 1, wherein selecting the second LoD comprises:
determining a position of the particular visual asset in the scene;
determining a third LoD that is assigned to a set of the plurality of visual assets at a same depth in the scene as the particular visual asset; and
increasing from the third LoD to the second LoD in response to the set of visual assets at the same depth in the scene as the particular visual asset being assigned the third LoD.

8. The method of claim 1 further comprising:
retrieving an original encoding of each visual asset from the plurality of visual assets;
downsampling each visual asset of the plurality of visual assets except for the particular visual asset by a first amount that reduces a maximum LoD of the original encoding for each visual asset to the at least first LoD; and
downsampling the particular visual asset by a second amount that reduces a maximum LoD of the particular visual asset to the second LoD, wherein the second amount is less than the first amount.

9. The method of claim 1 further comprising:
retrieving an original encoding of each visual asset from the plurality of visual assets;
modifying the original encoding of each visual asset of the plurality of visual assets except for the particular visual asset by reducing a fidelity of the original encoding of each visual asset to match a fidelity associated with the at least first LoD; and
modifying the original encoding of the particular visual asset by changing a fidelity of the original encoding of the particular visual asset to match a fidelity associated with the second LoD.

10. The method of claim 1, wherein the scene corresponds to a three-dimensional (3D) environment and each visual asset of the plurality of visual assets corresponds to different 3D content that is included in the 3D environment.

11. The method of claim 10, wherein each visual asset of the plurality of visual assets is a different 3D mesh model, point cloud, or Gaussian splat representation of a 3D object.

12. The method of claim 1 further comprising:
determining a maximum amount of data for rendering the scene at a given frame rate based on available resources; and
adjusting the at least first LoD and the second LoD until aggregate data for the plurality of visual assets at an adjusted LoD is equal to or less than the maximum amount of data.

13. A scene generation system comprising:
one or more hardware processors configured to:
receive a request to promote a particular visual asset from a plurality of visual assets that form a scene;
determine at least a first level-of-detail (LoD) at which to render the plurality of visual assets;
select a second LoD that is greater than the first LoD for the particular visual asset in response to receiving the request to promote the particular visual asset; and
present the scene by rendering each visual asset of the plurality of visual assets except for the particular visual asset at the at least first LoD and the particular visual asset at the second LoD.

14. The scene generation system of claim 13,
wherein rendering each visual asset of the plurality of visual assets except for the particular visual asset at the at least first LoD comprises:
generating a visualization for each visual asset of the plurality of visual assets except for the particular visual asset in the scene with a first resolution or fidelity; and
wherein rendering the particular visual asset at the second LoD comprises:
generating a visualization for the particular visual asset in the scene with a second resolution or fidelity that is greater than the first resolution or fidelity.

15. The scene generation system of claim 13, wherein said rendering comprises:
generating a visualization for each visual asset of the plurality of visual assets except for the particular visual asset in the scene with a reduced clarity, detail, or sharpness relative to a visualization that is generated for the particular visual asset in the scene.

16. The scene generation system of claim 13,
wherein determining the at least first LoD comprises:
selecting the first LoD for a first set of visual assets that are positioned in a background or a periphery of the scene, and a third LoD for a second set of visual assets that are positioned in a foreground or a center of the scene; and
wherein selecting the second LoD comprises:
increasing the first LoD to the second LoD for the particular visual asset in response to the particular visual asset being located in the background or the periphery of the scene and the second LoD being less than the third LoD.

17. The scene generation system of claim 13,
wherein determining the at least first LoD comprises:
selecting the first LoD for a first set of visual assets that are positioned in a a foreground or a center of the scene, and a third LoD for a second set of visual assets that are positioned in a background or a periphery of the scene; and
wherein selecting the second LoD comprises:
increasing the first LoD to the second LoD for the particular visual asset in response to the particular visual asset being located in the foreground or the center of the scene and the second LoD being greater than the third LoD.

18. The scene generation system of claim 13, wherein the one or more hardware processors are further configured to:
receive a monetary compensation with the request to promote the particular visual asset.

19. The scene generation system of claim 13, wherein selecting the second LoD comprises:
determining a position of the particular visual asset in the scene;
determining a third LoD that is assigned to a set of the plurality of visual assets at a same depth in the scene as the particular visual asset; and
increasing from the third LoD to the second LoD in response to the set of visual assets at the same depth in the scene as the particular visual asset being assigned the third LoD.

20. A non-transitory computer-readable medium storing instructions that, when executed by one or more processors of a scene generation system, cause the scene generation system to perform operations comprising:
receiving a request to promote a particular visual asset from a plurality of visual assets that form a scene;
determining at least a first level-of-detail (LoD) at which to render the plurality of visual assets;
selecting a second LoD that is greater than the first LoD for the particular visual asset in response to receiving the request to promote the particular visual asset; and
presenting the scene by rendering each visual asset of the plurality of visual assets except for the particular visual asset at the at least first LoD and the particular visual asset at the second LoD.
